(19) United States
(12) Patent Application Publication
(10) Pub. No.: US 2015/0250132 A1
(43) Pub. Date: Sep. 10, 2015

(54) Method for Forming Shapes Containing Multiple Natural Cheeses

(71) Applicant: Sargento Foods, Inc., Plymouth, WI (US)

(72) Inventors: John K. Brody, Plymouth, WI (US); Craig S. Hackl, Fond du Lac, WI (US); Phillip Delpierre, III, Plymouth, WI (US); John D. Adams, Sheboygan, WI (US)

(73) Assignee: Sargento Foods, Inc., Plymouth, WI (US)

(21) Appl. No.: 14/196,888

(22) Filed: Mar. 4, 2014

(51) Int. Cl. A01J 25/12

(52) U.S. Cl. CPC A01J 25/12

(57) ABSTRACT

A method of providing cheese shapes including two or more natural cheeses is provided. The method includes mixing pieces of a first cured natural cheese and a second natural cheese. The method includes applying pressure to the mixed pieces of the first cured natural cheese and the second natural cheese to form a block of cheese. The method includes curing the block of cheese. The method includes cutting the block of cheese into shapes.

### BACKGROUND OF THE INVENTION

### Field of the Invention

The present invention relates generally to cheese, and more particularly to methods for forming cheese shapes containing multiple different natural cheeses.

Natural cheese may be formed in blocks, which may then by cut into various shapes (e.g., slices, sticks, cubes, wedges, snacks, etc.). To make natural cheese blocks and shapes with more than one different type of natural cheese, e.g., Colby Jack cheese, etc., two different types of fresh natural cheese curds are prepared so that they are both ready at approximately the same time, with the curds being at approximately the same pH. The two different types of curds are then combined, formed into a block, cured, and cut into shapes.

The subject matter discussed in this background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions.

### SUMMARY OF THE INVENTION

In one embodiment, a method of providing cheese shapes including two natural cheeses is provided. The method includes mixing pieces of a first cured natural cheese and curds of a second natural cheese. The method includes applying pressure to the mixture of the pieces of the first cured natural cheese and the curds of the second natural cheese to form a block. The method includes curing the block. The method includes cutting the block into shapes.

In another embodiment, a method of providing cheese shapes including three natural cheeses is provided. The method includes mixing pieces of a first cured natural cheese, pieces of a second cured natural cheese different than the first cured natural cheese, and pieces of a third cured natural cheese different than the first cured natural cheese and the second cured natural cheese. The method includes applying vacuum to the mixture of the pieces of the first cured natural cheese, the second cured natural cheese, and the third cured natural cheese. The method includes applying pressure to the mixture of the pieces of the first cured natural cheese, the second cured natural cheese, and the third cured natural cheese to form a block. The method includes curing the block. The method includes cutting the block into cheese shapes including the three natural cheeses.

In another embodiment, a method of providing cheese shapes including two natural cheeses is provided. The method includes making curds of a first natural cheese. The method includes mixing the curds of the first natural cheese with pieces of a second cured natural cheese. The method includes applying pressure to the mixture of the curds of the first natural cheese and the pieces of the second cured natural cheese to form a block. The method includes cutting the block into shapes including the two natural cheeses.

Alternative exemplary embodiments relate to other features and combinations of features as may be generally recited in the claims.

### DESCRIPTION OF THE DRAWINGS

This application will become more fully understood from the following detailed description, taken in conjunction with the accompanying figures, wherein like reference numerals refer to like elements in which:

FIG. 1 is a flow chart illustrating an embodiment of a process for forming fresh curd of a type of cheese for use in embodiments of methods described below;

FIG. 2 is a flow chart illustrating additional steps to form curd into cured and/or aged blocks of natural cheese for use in embodiments of methods described below;

FIG. 3 is flow chart illustrating a first embodiment of a method for forming cheese shapes including multiple different types of natural cheese;

FIG. 4 is a flow chart illustrating a second embodiment of a method for forming cheese shapes including multiple different types of natural cheese;

FIG. 5 is a flow chart illustrating a third embodiment of a method for forming cheese shapes including multiple different types of natural cheese;

FIG. 6 is an illustration of an exemplary cheese block including two natural cheeses formed by an embodiment of a method described herein;

FIG. 7 is an illustration of an exemplary cheese block including two natural cheeses formed by an embodiment of a method described herein;

FIG. 8 is an illustration of an exemplary cheese block including two natural cheeses formed by an embodiment of a method described herein; and

FIG. 9 is an illustration of an exemplary cheese shape including two natural cheeses formed by an embodiment of a method described herein.

### DETAILED DESCRIPTION OF THE EXEMPLARY EMBODIMENTS

Generally, embodiments of methods for providing cheese shapes including multiple types of natural cheese are provided. When natural cheese blends are prepared by combining two different natural cheese curds, fresh curds of each of the two different natural cheeses to be combined are prepared so that the fresh curds of each are available at generally the same time, at generally the same pH level, etc. Fresh curd is generally produced from milk during the cheese making process and generally remains fresh for a period of approximately 24 hours or less. It may be difficult and/or impractical to prepare fresh curds of three or more different natural cheeses at a single cheese-making facility. Additionally, it may be difficult and/or impractical to prepare fresh curds of three or more fresh different natural cheeses such that they are available at generally the same time, at generally the same pH, etc., at some a single cheese making facility. Additionally, transporting different types of fresh curd from different locations while maintaining the fresh curds at acceptable conditions and within limited time to a single location to combine the different types to form a combination may be difficult and/or costly and/or impractical.

Embodiments of methods described below provide for forming cheese shapes with two or more (e.g., three, four, five, six, etc.) different types of natural cheese without having fresh curds of each of the different natural cheese types being provided at generally the same time, at generally the same pH level, etc.

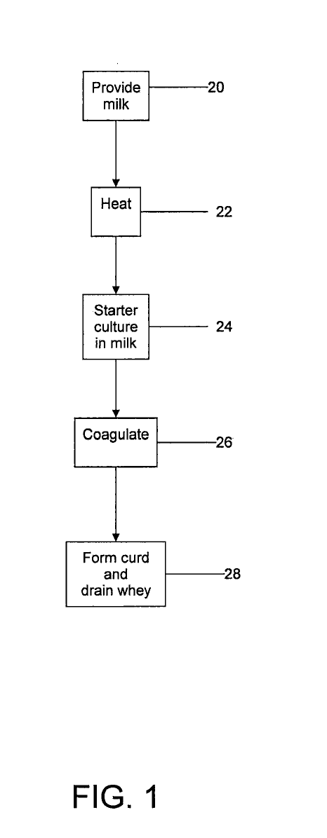

FIG. 1 generally illustrates an embodiment of a process for forming fresh curd of one type of cheese. In step 20, milk is provided. The milk may be pasteurized or unpasteurized. The milk may be cow's milk, sheep's milk, buffalo's milk, goat's milk, or any other suitable type of milk. In step 22, the milk is heated. In step 24, the temperature of the milk is controlled to between 88° Fahrenheit and 100° Fahrenheit and a starter culture (e.g., Lactobacillus lactis ssp. lactis, Lactobacillus lactis ssp. cremoris, Streptococcus thermophilus, Lactobacillus helveticus, Lactobacillus bulgaricus, etc.) is added to the milk.

For purposes of this disclosure, milk may include, for example, fresh liquid milk, milk protein concentrate, rehydrated nonfat dry milk powder, concentrated skim milk, filtered milk (for example, milk filtered to remove water and/or lactose), etc.

In step 26, rennet may be added to the milk and starter culture mixture and the mixture is coagulated. In step 28, the curd is formed and the whey is drained from the curd. This process results in the formation of fresh curd, which may be used in embodiments of methods described further below. The curd may be fresh curd of various types of cheese, e.g., Cheddar, Colby, Monterey Jack, Swiss, low moisture part skim (LMPS) Mozzarella, whole milk (W.M.) Mozzarella, Provolone, Parmesan, etc.

For purposes of this disclosure, natural cheese may be non-processed cheese. For example, processed cheese may be formed by heating cheese to a melting point and adding an emulsifier. Natural cheese may be cheese that is not formed by heating to a melting point and does not include an added emulsifier. Additionally, natural cheese may contain live bacteria, while processed cheese may not include live bacteria.

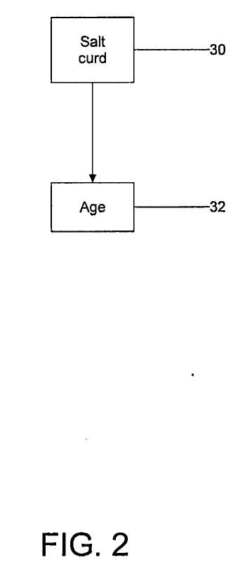

With reference to FIG. 2, in one embodiment, fresh cheese curd, such as, for example, cheese curd formed by the process illustrated in FIG. 1, may undergo the additional processing shown in FIG. 2 to form cured natural cheese. In step 30, the curd is salted. In step 32, the salted curd is aged, e.g., kept in temperature controlled conditions for between for example, two weeks to two years. In one embodiment, the temperature in which the salted curd is kept during aging is controlled between 34° Fahrenheit and 60° Fahrenheit. In another embodiment, the temperature in which the salted curd is kept during aging is controlled between 34° Fahrenheit and 50° Fahrenheit. In one embodiment, the salted curd is packaged for aging, e.g., vacuum packed, packed in plastic packaging, etc. Natural cheese formed by this process may be distinguished from processed cheese, for example, in that after the curds are formed, the curds or resultant cheese are not heated to their melting point and no additional emulsifiers, e.g., sodium citrate, sodium phosphate, di sodium phosphate, tri sodium phosphate, etc., are added to natural cheese curd or the resulting natural cured cheese. Natural cheese may have different textural and melting properties than process cheese. The flavor of natural cheese may increase with age, while the flavor of processed cheese may remain the same regardless of age.

Natural cured cheese formed by embodiments of the process described above may be used in embodiments of methods of providing cheese shapes including two natural cheeses as are described further below. In some embodiments, natural cheese does not include additives such as, e.g., an emulsifier, and may provide for better tasting, more organoleptically pleasing, more texturally pleasing, additive free natural cheese, which may be desirable.

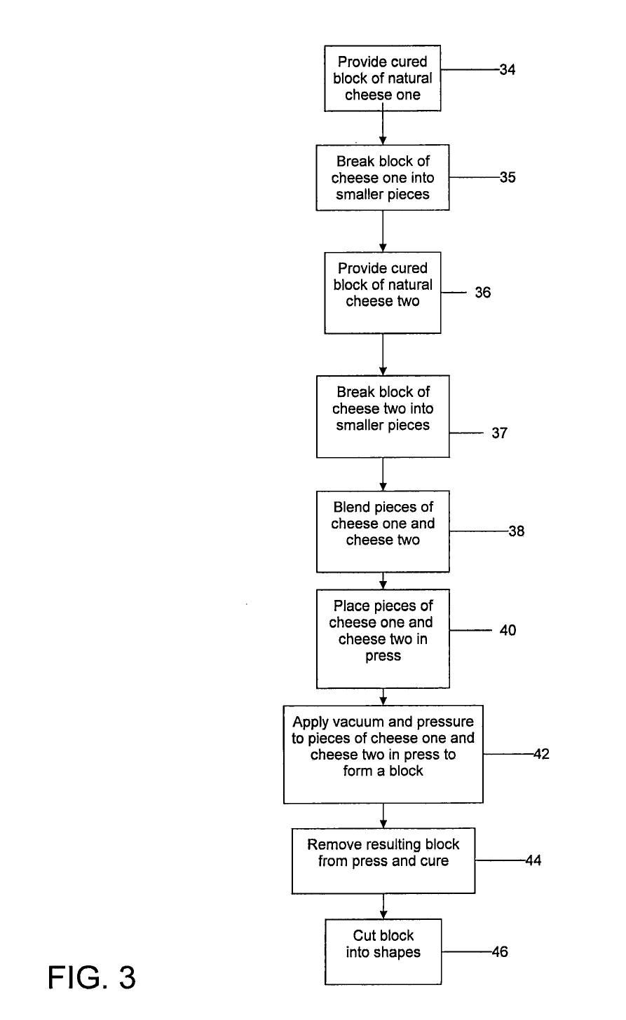

With reference to FIG. 3, a flow chart illustrating an embodiment of a method of forming cheese shapes including multiple natural cheeses is illustrated. In step 34, a block, e.g., a cohesive mass, etc., of a first natural cured cheese is provided. In one embodiment, cured natural cheese may be distinguished from natural cheese curd in that the cured cheese may have been aged for at least approximately two weeks, the texture of the cured cheese may be generally smoother and more cohesive relative to the rubbery texture of natural cheese curds, etc. In step 35, the first block is broken into smaller pieces. In one embodiment, the pieces are generally cube-shaped and have an average length, width, and height each of between approximately ⅛ inch and approximately 1 inch.

In another embodiment, the pieces are generally cube-shaped and have a length, width, and height each of between approximately ¼ inch and approximately ½ inch. In another embodiment, the pieces are generally cube-shaped and have a length, width, and height each of approximately ⅜ inch. In one embodiment, the pieces each have a length, a width, and a height, and the length, the width, and the height of each of the pieces are generally the same, e.g., on average the height is dimensioned generally similar to the length and generally similar to the width. In another embodiment, the block is shredded to form cheese shreds, e.g., with a cheese shredding machine such as, for example, a Model CCX-D shredder available from Urschel® Laboratories, Inc. or any other suitable cheese shredding machine.

In one embodiment, a cheese shred has a length, a width, and a height, with the length being generally greater than the width and height, e.g., in one embodiment, the length is at least two times greater than each of the width and the height, in another embodiment, the length is at least three times greater than each of the width and the height. Additionally, in one embodiment, a shred has a width that is greater than the height (but less than the length), e.g., in one embodiment the width is at least two times greater than the height, in another embodiment, the width is at least three times greater than the height, etc.

In another embodiment, the block is extruded to form the smaller pieces. In another embodiment, the block may be cut and/or diced into small, generally cube-shaped portions, e.g., 1/16 inch by 1/16 inch by 1/16 inch, etc. In another embodiment, the block may be torn into smaller pieces, e.g., by a crumbler, pin mill, etc. In other embodiments, other suitable

In one embodiment, the first block is not broken into smaller pieces by an extruder or an auger, which may have an effect on the structure of cheese, which in some embodiments may be undesirable, e.g., may result in cheese shapes with less desirable texture, etc., but is instead cut, which may allow the cheese pieces to retain their structure and which may result in cheese shapes with more desirable texture, etc.

In step 36, a block of a cured second natural cheese, e.g., a type of cheese different than the first natural cheese, is provided. In step 37, the second block is broken into smaller pieces. In one embodiment, the smaller pieces of the second block may be similarly sized, shaped, dimensioned, etc., as the smaller pieces of the first block and may be formed in the same manner or a different manner than the smaller pieces of the first block. In another embodiment, the smaller pieces of the second block may be dissimilarly sized, shaped, dimensioned, etc., than the smaller pieces of the first block.

In one embodiment, the first and second cured natural cheeses may be cheese formed such as, for example, by the process illustrated in FIG. 2.

In step 38, the pieces of the first cheese and the pieces of the second cheese are blended and/or mixed together, e.g., in a tumble drum, etc. The ratio of the amount of the first cheese and the amount of the second cheese may vary. In various embodiments, the first cured natural cheese may be provided in amounts of any suitable ratio relative to the second cured natural cheese, e.g., 50% first cured natural cheese and 50% second cured natural cheese, 90% first cured natural cheese and 10% second cured natural cheese, etc. In one embodiment, no flow agent, e.g., cellulose, blend of potato starch and cellulose, cellulose and natamycin blend, blend of potato starch, cellulose, and natamycin, etc., is added to the blended and/or mixed cheeses. In one embodiment, the temperature of the blended and/or mixed pieces of the first and second cheeses is controlled and/or regulated to between approximately 60° Fahrenheit and approximately 70° Fahrenheit. In another embodiment, the temperature of the blended and/or mixed pieces of the first and second cheeses is controlled to approximately 65° Fahrenheit.

In step 40, the blended and/or mixed pieces of the first cheese and the second cheese are located in a press. In one embodiment, the press is a programmable tunnel press, such as those available from Johnson Industries International Inc.

In step 42, the pieces of the first and second cheeses are subjected to vacuum and pressure in the press to form the pieces into a block, e.g., a cohesive mass. In one embodiment, vacuum is first applied and then pressure is applied. In another embodiment, the vacuum and pressure are applied generally simultaneously. In another embodiment, pressure is applied and then vacuum is applied.

In one embodiment, the pieces are subjected to pressure and/or vacuum for between approximately 5 minutes and approximately 5 hours. In another embodiment, the pieces are subjected to pressure and/or vacuum for between approximately 10 minutes and approximately 1 hour. In another embodiment, the pieces are subjected to pressure and/or and vacuum for approximately 20 minutes.

In one embodiment, the mixed cheese pieces are subjected to a pressure of between approximately 10 pounds per square inch (PSI) and approximately 100 PSI, e.g., the pressure applied to the surface of the cheese mixture is between 10 PSI and 100 PSI. In another embodiment, the mixed cheese pieces are subjected to a pressure of between approximately 30 PSI and approximately 50 PSI. In another embodiment, the mixed cheese pieces are subjected to a pressure of approximately 40 PSI. In another embodiment, pressure of between 8 PSI and 16 PSI is applied to the surface of the mixture of cheese pieces.

In one embodiment, the mixed cheese pieces are subjected to a vacuum of between approximately 10 mm Hg and approximately 50 mm Hg. In another embodiment, the mixed cheese pieces are subjected to a vacuum of between approximately 20 mm Hg and approximately 40 mm Hg. In another embodiment, the mixed cheese pieces are subjected to a vacuum of approximately 30 mm Hg.

In step 44, the cheese block formed from the mixed cheese pieces in the press is removed from the press and cured. In one embodiment, the cheese block is vacuum packaged and cured. In one embodiment, the block is cured for between approximately 1 day and approximately 1 month. In another embodiment, the block is cured for between approximately 1 week and approximately 3 weeks. In another embodiment, the block is cured for approximately 2 weeks.

In step 46, the cured block containing the two natural cheeses is cut into shapes, e.g., slices, such as generally rectangular and/or square slices, wedges, sticks, cubes, snacks, etc. The cheese shapes containing the two different types of cured natural cheeses may then be packaged and sold.

While the embodiment of the method illustrated in FIG. 3 discloses blending two types of cheeses, in another embodiment, a third type of cured natural cheese, different from the first and second types of cheese, is provided, e.g., in a block, broken into smaller pieces, blended and/or mixed with the first and second cheese pieces, pressed, and a resulting cheese shape is formed containing the first, second, and third natural cured cheeses.

In another embodiment, a fourth type of cured natural cheese, different from the first, second, and third types of cheese, is provided, e.g., in a block, broken into smaller pieces, blended and/or mixed with the first, second, and third cheese pieces, pressed, and a resulting cheese shape is formed containing the first, second, third, and fourth natural cured cheeses.

In other embodiments, any other suitable numbers of types of cured natural cheeses may be used to produce cheese shapes containing all of the different types of natural cured cheeses according to the embodiment of the method described above.

The embodiment of the method illustrated in FIG. 3 provides for forming cheese shapes including multiple natural cheeses without providing fresh curds, e.g., curds that are less than approximately 24 hours old, curds that are fresh enough to bond and/or knit with themselves to form a cohesive piece of cheese when pressed and molded, etc., of multiple different natural cheeses at approximately the same time, which may be advantageous, e.g., avoids difficulty, expense, etc., of making fresh curds of different cheeses available at approximately the same time, controlling pH level of fresh curds of different cheeses, facilitates making cheese shapes including multiple natural cheeses at cheese-making facilities that may not be configured to produce multiple different types of fresh cheese curd concurrently, etc.

Additionally, the method of FIG. 3 provides for the first natural cheese and the second natural cheese to be made at different locations, e.g., the first cheese may be made at a first location and shipped to a second location where the second cheese is made and where the first cheese may be combined with the second cheese to form the cheese shapes including two natural cheeses, the first cheese and the second cheese may each be made at different locations and each be shipped to a third location where the first cheese may be combined with the second cheese to form the cheese shapes including two natural cheeses, etc.

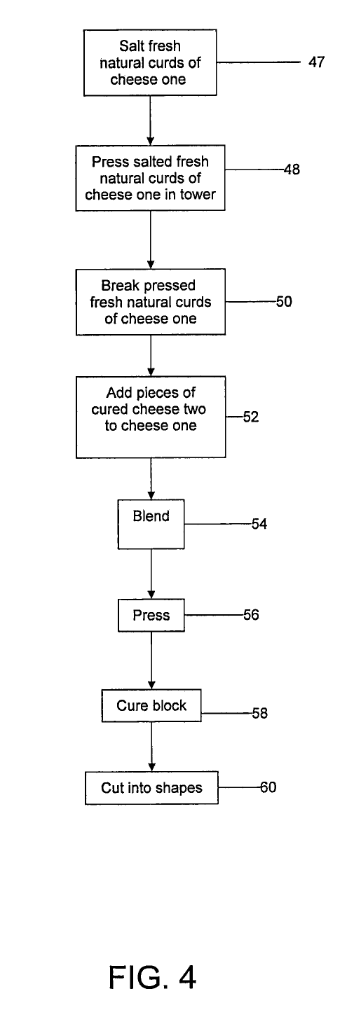

With reference to FIG. 4, a flow diagram illustrating another embodiment of a method of forming cheese shapes including multiple different natural cheeses is provided. In step 47, salt is added to fresh curds e.g., curds that are less than approximately 24 hours old, curds that are fresh enough to bond and/or knit with themselves to form a cohesive piece of cheese when pressed and molded, etc., of a first type of natural cheese, such as, for example, curds formed by the method illustrated in FIG. 1. In step 48, the fresh salted natural curds of cheese one are pressed in a tower, e.g., pressure is applied to the curds to evacuate whey from the curds, which may then be drained, etc., in a tower such as those available from, for example, Wincanton Cheese Systems, a Tetra Tebel Blockformer® available from Tetra Pak International S.A., etc. In one embodiment, the tower is a tower configured to produce an approximately 40 lb. block of pressed curd.

In one embodiment, the fresh curd may be pressed in the tower and broken up by, e.g., a curd breaker, e.g., to control and/or reduce the moisture in the curd.

In step 50, the pressed fresh natural curd of the first cheese from the tower is broken into smaller pieces, e.g., by a curd breaker. The smaller pieces may be of similar size as the size of the original curd prior to pressing. In one embodiment, the pieces may be between one inch and two inches in length on average.

In step 52, pieces of a second natural cured cheese of a different type than the first cheese are provided. In one embodiment, the pieces may be shreds. In another embodiment, the pieces may be generally cube-shaped, such as those described above with regard to the previous embodiment. In other embodiments, the pieces may be any other suitable shape. The pieces of the second natural cured cheese are added to the fresh natural first cheese curds. In step 54, the fresh natural first cheese curds and the second natural cured cheese pieces are blended together, e.g., mixed, tumbled in a tumble drum, etc.

In step 56, the mixed first cheese curd and second cured cheese pieces are pressed together, e.g., pressure and vacuum are applied to the mixed curd and cheese pieces in a cheese mold, such as, for example, a cheese mold configured to produce approximately 40 lb. blocks of cheese, a cheese mold configured to produce approximately 640 lb. blocks of cheese, etc.

In one embodiment, the mixture remains in the cheese mold, e.g., the 40 lb. cheese mold, from between 2 hours to 24 hours. In another embodiment, the mixture remains in the cheese mold, e.g., the 640 lb. cheese mold, from between ten days to 10 months. Once in the cheese mold, e.g., the 40 lb. cheese mold, in one embodiment, the temperature of the environment in which the cheese is located is controlled from approximately 100° Fahrenheit down to approximately 60° Fahrenheit. In another embodiment, once in the cheese mold, e.g., the 640 lb. cheese mold, the temperature of the environment in which the cheese is located is controlled from approximately 100° Fahrenheit down to about 36° Fahrenheit. In one embodiment, in the cheese mold pressure between approximately 20 psi and approximately 100 psi is applied to the cheese mixture. In another embodiment, in the cheese mold, vacuum of between 29 inches of Mercury and 30 inches of Mercury is applied to the cheese mixture.

In step 58, the block of cheese formed in the mold containing the first and second natural cheeses is removed from the tower and cured. In one embodiment, a block of cheese formed in the 40 lb. mold is vacuum sealed in plastic and/or sealed in wood and located in a cooler in which the temperature is maintained between 36° Fahrenheit and 50° Fahrenheit to cure. In another embodiment, a block of cheese formed in the 640 lb. mold is located in a cooler in which the temperature is maintained between 36° Fahrenheit and 50° Fahrenheit to cure, e.g., the 640 lb. block may not be vacuum sealed in plastic. In various embodiments, a block of cheese may be allowed to cure from between 2 weeks to 10 months to 2 years.

In another embodiment, the block is cured for between approximately 1 week and approximately 3 weeks. In another embodiment, the block is cured for approximately 2 weeks. In step 60, the cured block containing two different natural cheeses is cut into shapes (e.g., slices, such as generally rectangular and/or square slices, sticks, wedges, cubes, snacks, etc.). The shapes may then be packaged and sold.

While the embodiment illustrated in FIG. 4 blends two types of cheeses, in another embodiment, a third type of cured natural cheese, different from the first and second types of cheese, is provided, e.g., in a block, broken into smaller pieces, blended and/or mixed with the first natural cheese curds and the second cured natural cheese pieces, pressed, and a resulting cheese shape is formed containing the first, second, and third natural cheeses.

In another embodiment, a fourth type of cured natural cheese, different from the first, second, and third types of cheese, is provided, e.g., in a block, broken into smaller pieces, blended and/or mixed with the first fresh natural cheese curds, the second natural cured cheese pieces, and the third natural cured cheese pieces, pressed, and a resulting cheese shape is formed containing the first, second, third, and fourth natural cheeses.

In other embodiments, any other suitable numbers of types of cured natural cheeses may be used to produce cheese shapes containing all of the different types of natural cured cheeses according to the embodiment of the method described above.

The embodiment of the method illustrated in FIG. 4 provides for forming cheese shapes including multiple natural cheeses without providing fresh curds of multiple different natural cheeses at approximately the same time, which may be advantageous, e.g., avoids difficulty, expense, etc., of making fresh curds of different cheeses available at approximately the same time, controlling pH level of fresh curds of different cheeses, facilitates making cheese shapes including multiple natural cheeses at cheese-making facilities that may not be configured to produce multiple different types of fresh cheese curd concurrently, etc. Additionally, the method of FIG. 4 provides for the first natural cheese curd and the second natural cheese being made at different locations, e.g., the first cheese curd may be made at a first location and the second natural cheese may be made at a second location and shipped to the first location where the first cheese curd may be combined with the second cheese to form the cheese shapes including two natural cheeses, etc.

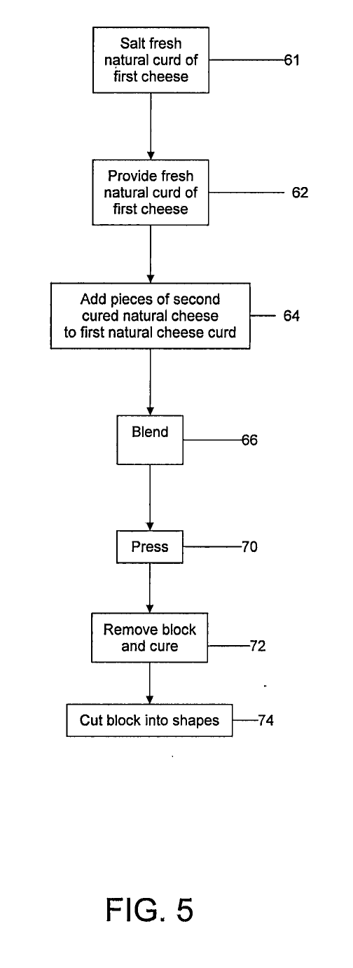

With reference to FIG. 5, a flow diagram illustrating another embodiment of a method for forming cheese shapes including multiple different natural cheeses is illustrated. In step 61, salt is added to fresh natural curds of a first cheese. In one embodiment, the fresh natural curd which is salted may be formed, such as by the embodiment of the method described with respect to FIG. 1 above. In step 62, the salted fresh natural curd of the first cheese is provided for undergoing the further steps illustrated in FIG. 5. In step 64, pieces of a second cured natural cheese, different than the first cheese, are provided and added to the fresh natural curds of the first cheese. In one embodiment, the pieces of the second cured natural cheese may be shreds. In another embodiment, the pieces of the second cured natural cheese may be generally cube-shaped, e.g., such as those described with respect to the embodiments above. In other embodiments, other suitable shapes of pieces of second cured natural cheese may be used.

In step 66, the fresh natural curds of the first cheese and the pieces of the second cured natural cheese are blended and/or mixed together, e.g., mixed, tumbled in a tumble drum, etc.

In step 70, the mixture is placed in a mold and pressed into a block, e.g., pressure and vacuum are applied to the mixture. In one embodiment, pressure of between 20 PSI and 100 PSI is applied to the surface of the mixture in the mold. In one embodiment, vacuum of between approximately 29 inches of Mercury and approximately 30 inches of Mercury is applied to the mixture in the mold. In one embodiment, pressure and/or vacuum is applied to the mixture in the mold for between 30 minutes and 6 hours.

In step 72, the block of cheese formed in the press containing the first and second natural cheeses is removed from the press and cured. In one embodiment, a block of cheese formed in a 40 lb. mold is vacuum sealed in plastic and/or sealed in wood and located in a cooler in which the temperature is maintained between 36° Fahrenheit and 50° Fahrenheit to cure. In another embodiment, a block of cheese formed in a 640 lb. mold is located in a cooler in which the temperature is maintained between 36° Fahrenheit and 50° Fahrenheit to cure, e.g., the 640 lb. block may not be vacuum sealed in plastic. In various embodiments, a block of cheese may be allowed to cure from between 2 weeks to 10 months to 2 years. In another embodiment, the block is cured for between approximately 1 week and approximately 3 weeks. In another embodiment, the block is cured for approximately 2 weeks. In step 74, the cured block containing two different natural cheeses is cut into shapes (e.g., slices, such as generally rectangular and/or square slices, sticks, wedges, cubes, snacks, etc.). The shapes may then be packaged and sold.

While the embodiment illustrated in FIG. 5 blends two types of cheeses, in another embodiment, a third type of cured natural cheese, different from the first and second types of cheese, is provided, e.g., in a block, broken into smaller pieces, blended and/or mixed with the first natural cheese curds and the second cured natural cheese pieces, pressed, and a resulting cheese shape is formed containing the first, second, and third natural cheeses.

In another embodiment, a fourth type of cured natural cheese, different from the first, second, and third types of cheese, is provided, e.g., in a block, broken into smaller pieces, blended and/or mixed with the first fresh natural cheese curds, the second natural cured cheese pieces, and the third natural cured cheese pieces, pressed, and a resulting cheese shape is formed containing the first, second, third, and fourth natural cheeses.

In other embodiments, any other suitable numbers of types of cured natural cheeses may be used to produce cheese shapes containing all of the different types of natural cured cheeses according to the embodiment of the method described above.

The embodiment of the method illustrated in FIG. 5 provides for forming cheese shapes including multiple natural cheeses without providing fresh curds of multiple different natural cheeses at approximately the same time, which may be advantageous, e.g., avoids difficulty, expense, etc., of making fresh curds of different cheeses available at approximately the same time, controlling pH level of fresh curds of different cheeses, facilitates making cheese shapes including multiple natural cheeses at cheese-making facilities that may not be configured to produce multiple different types of fresh cheese curd concurrently, etc. Additionally, the method of FIG. 5 provides for the first natural cheese curd and the second natural cheese being made at different locations, e.g., the first cheese curd may be made at a first location and the second cheese may be made at a second location and shipped to the first location where the first cheese curd may be combined with the second cheese to form the cheese shapes including two natural cheeses, etc.

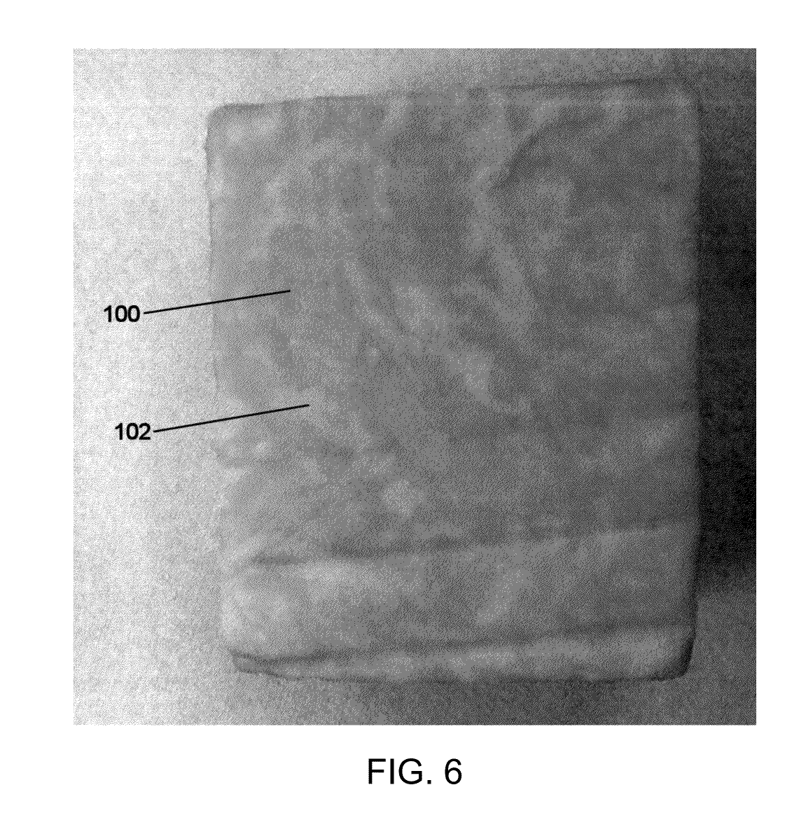

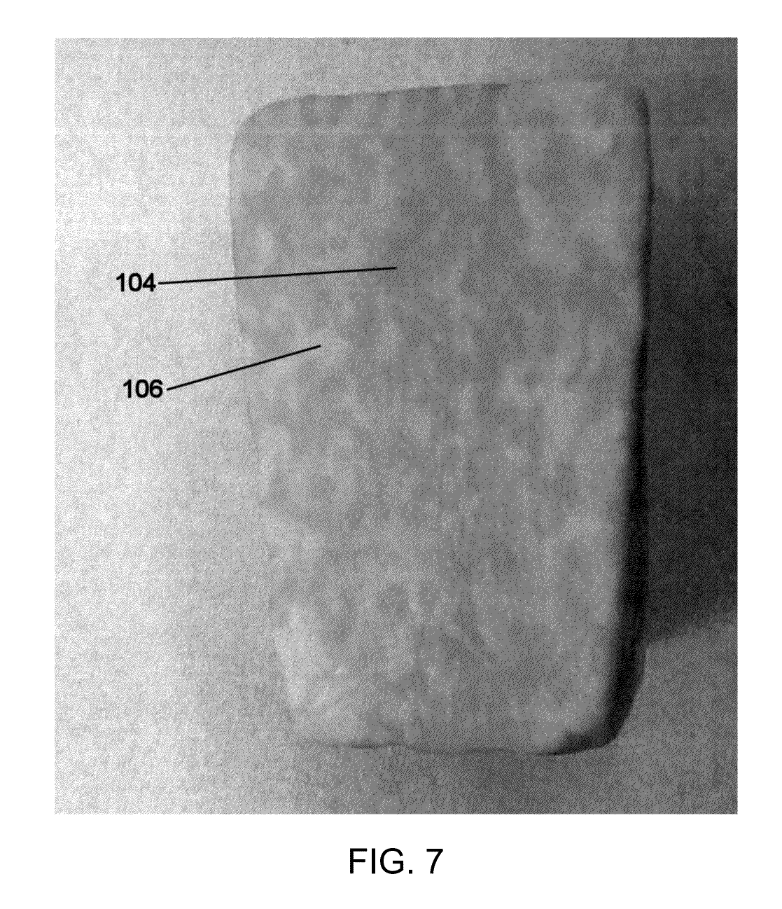

With reference to FIGS. 6-8, exemplary embodiments of cheese blocks formed by embodiments of methods described above are illustrated. FIG. 6 illustrates a block of cheese including a first natural cheese 100 and a second natural cheese 102. FIG. 7 illustrates a block of cheese including a first natural cheese 104 and a second natural cheese 106. The blocks of cheese illustrated in FIGS. 6 and 7 were formed by the embodiment of the method described with respect to FIG. 3.

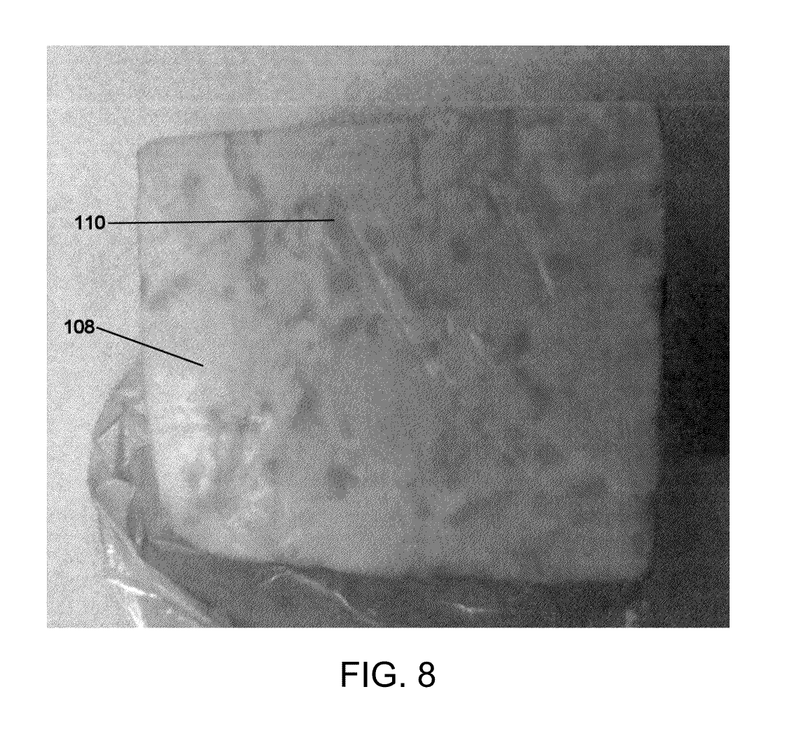

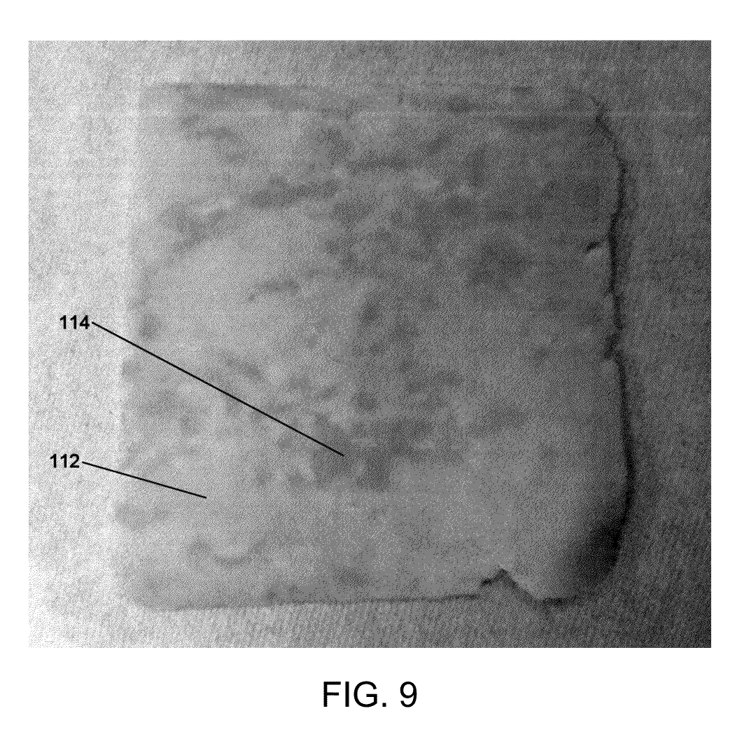

FIG. 8 illustrates a block of cheese including a first natural cheese 108 and a second natural cheese 110. FIG. 9 illustrates a cheese shape shown as a generally rectangular slice of cheese including a first natural cheese 112 and a second natural cheese 114. The cheese illustrated in FIGS. 8 and 9 were formed by the embodiment of the method described with respect to FIG. 4. The second natural cheese 110 and the second natural cheese 114 were formed from cured natural cheese pieces added in step 52 of FIG. 4. As is illustrated in FIGS. 8 and 9, the second natural cheeses 110 and 114 extend generally throughout the blocks, e.g., vein generally throughout the block, are interspersed among the first cheeses 108 and 112, etc. This may provide an interesting visual appeal of the cheese, e.g., when the cheese block is cut into cheese shapes, which may be desirable.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

In each of the embodiments of methods described above, the different cured natural cheeses and natural curds may be provided and combined in various different suitable amounts and/or ratios.

Embodiments of the methods described above may allow for creating cheese shapes containing cheeses of difference ages, subjected to different curing and/or aging processes, etc.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. The position of elements may be reversed or otherwise varied, and the nature or number of discrete elements or positions may be altered or varied. The order or sequence of some process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

What is claimed is:

1. A method of providing cheese shapes including two natural cheeses, the method comprising:
mixing pieces of a first cured natural cheese and curds of a second natural cheese;
applying pressure to the mixture of the pieces of the first cured natural cheese and the curds of the second natural cheese to form a block;
curing the block; and
cutting the block into shapes.

2. The method of claim 1, further comprising mixing pieces of at least one of a third cured natural cheese and curds of a third natural cheese with the pieces of the first cured natural cheese and the curds of the second natural cheese.

3. The method of claim 1, further comprising applying vacuum to the mixed pieces of the first cured natural cheese and the curds of the second natural cheese while pressure is applied to the mixed pieces of the first cured nature cheese and the curds of the second natural cheese.

4. The method of claim 1, wherein the pieces of the first cured natural cheese are one of shreds and generally cube-shaped pieces.

5. The method of claim 1, further comprising producing the curds of the second natural cheese, wherein the producing includes a moisture reduction step configured to reduce the moisture in the curds of the second natural cheese.

6. The method of claim 5, wherein the moisture reduction step includes applying pressure to the second natural cheese curds to form a block of the second natural cheese curds and to drain whey from the second natural cheese curds, and breaking the block of the second natural cheese curds into pieces before mixing the pieces of the first cured natural cheese and the pieces of the second natural cheese curds.

7. The method of claim 5, wherein the moisture reduction step includes at least one of during forming of the curds controlling the temperature of milk to which a starter culture and rennet are added to between approximately 101° Fahrenheit and approximately 110° Fahrenheit and cutting the curds to approximately on average less than ⅛ cubic inch in volume.

8. The method of claim 2, further comprising providing pieces of a fourth cured natural cheese and mixing the pieces of the fourth cured natural cheese with the pieces of the first cured natural cheese, the curds of the second natural cheese, and the at least one of the third cured natural cheese and the curds of the third natural cheese.

9. The method of claim 1, further comprising regulating the temperature of the mixed pieces of the first cured natural cheese and the second natural cheese curds to between approximately 60° Fahrenheit and approximately 70° Fahrenheit.

10. The method of claim 1, further comprising adding salt to the curds of the second natural cheese.

11. A method of providing cheese shapes including three natural cheeses, the method comprising:
mixing pieces of a first cured natural cheese, pieces of a second cured natural cheese different than the first cured natural cheese, and pieces of a third cured natural cheese different than the first cured natural cheese and the second cured natural cheese;
applying vacuum to the mixture of the pieces of the first cured natural cheese, the second cured natural cheese, and the third cured natural cheese;
applying pressure to the mixture of the pieces of the first cured natural cheese, the second cured natural cheese, and the third cured natural cheese to form a block;
curing the block; and
cutting the block into cheese shapes including the three natural cheeses.

12. The method of claim 11, further comprising cutting a block of the first cured natural cheese to form the first cured natural cheese pieces, cutting a block of the second cured natural cheese to form the second cured natural cheese pieces, and cutting a block of the third cured natural cheese to form the third cured natural cheese pieces.

13. The method of claim 12, wherein the block of the first cured natural cheese is made at a first location; wherein the block of the second cured natural cheese is made at a second location different than the first location, the method comprising shipping the first cured natural cheese to the second location.

14. The method of claim 11, further comprising mixing pieces of a fourth cured natural cheese different than the first cured natural cheese, the second cured natural cheese, and the third cured natural cheese with the pieces of the first cured natural cheese, the pieces of the second cured natural cheese, and the pieces of the third cured natural cheese.

15. The method of claim 11, wherein the first cured natural cheese is one of cheddar, Colby, Monterey Jack, Swiss, LMPS Mozzarella, W.M. Mozzarella, Provolone, and Parmesan;
wherein the second the second cured natural cheese is a different one of cheddar, Colby, Monterey Jack, Swiss, LMPS Mozzarella, W.M. Mozzarella, Provolone, and Parmesan; and
wherein the third cured natural cheese is the same one of cheddar, Colby, Monterey Jack, Swiss, LMPS Mozzarella, W.M. Mozzarella, Provolone, and Parmesan as the second cured natural cheese aged for a longer time period than the second cured natural cheese.

16. A method of providing cheese shapes including two natural cheeses, the method comprising:
making curds of a first natural cheese;
mixing the curds of the first natural cheese with pieces of a second cured natural cheese;
applying pressure to the mixture of the curds of the first natural cheese and the pieces of the second cured natural cheese to form a block; and
cutting the block into shapes including the two natural cheeses.

17. The method of claim 16, further comprising applying pressure to the curds of the first natural cheese and draining whey from the curds of the first natural cheese before mixing the curds of the first natural cheese with the pieces of the second cured natural cheese.

18. The method of claim 16, further comprising adding salt to the curds of the first natural cheese prior to mixing the curds of the first natural cheese with the pieces of the second cured natural cheese.

19. The method of claim 16, further comprising applying vacuum to the mixture of the curds of the first natural cheese and the pieces of the second cured natural cheese prior to applying pressure to the mixture of the curds of the first natural cheese and the pieces of the second cured natural cheese.

20. The method of claim 16, wherein the shapes are slices.
